(19) United States
(12) Patent Application Publication
(10) Pub. No.: US 2008/0029543 A1
(43) Pub. Date: Feb. 7, 2008

(54) Beverage cooling and dispensing device

(76) Inventors: Martin Leufgen, Euskirchen (DE); Ralph Skerra, Hamm (DE)

Correspondence Address: WILLIAM COLLARD;COLLARD & ROE, P.C., 1077 NORTHERN BOULEVARD, ROSLYN, NY, 11576, US

(21) Appl. No.: 11/784,002

(22) Filed: Apr. 5, 2007

(30) Foreign Application Priority Data
Apr. 7, 2006 (DE) 10 2006 016 870.4

(51) Int. Cl. B67D 5/62; B65D 83/00

(52) U.S. Cl. 222/146.6; 222/399; 222/400.7

(57) ABSTRACT

A beverage cooling and dispensing device has a tapping unit that can be connected with a beverage supply container, particularly with a five-liter party keg, and can be connected with a tap by way of a line. The beverage cooling and dispensing device is furthermore equipped with a cooling device for cooling a beverage in the beverage supply container and/or in the line, and with a compressed gas system.

### BACKGROUND OF THE INVENTION

1. Field of the Invention

The invention relates to a beverage cooling and dispensing device, having a tapping unit that can be connected with a beverage supply container such as a five-liter party keg, and can be connected with a tap by way of a line. The dispensing device has a cooling device for cooling a beverage in the beverage supply container and/or in the line; and has a compressed gas system.

2. The Prior Art

Five-liter party kegs are often used for private parties or in at-home bars, in order to dispense beer or other beverages either by means of pressure-free dispensing or by means of a carbonation beer dispensing device. In part, beverage supply containers having a different capacity, of approximately 3 L to approximately 8 L, are also used in the home sector.

A beverage cooling and dispensing device is known from German Patent No. DE 197 20 553 C2, which is suitable for use in a five-liter party keg. With this previously known device, CO₂ cartridges are used as the compressed gas source for dispensing the beverage. These cartridges are screwed into a corresponding connector on the compressed gas line by way of a sleeve having a thread. This process of screwing the cartridge in is often perceived as being difficult and time-consuming. Furthermore, the pressure of the compressed gas cannot be automatically adapted to the pressure and/or the temperature of the beverage. Therefore, over-carbonation or under-carbonation of the beverage can occur.

Particularly when used in the home sector, cleaning of such a device also frequently represents a problem. Thus it is recommended to flush through at least those components of the device that come into contact with the beverage after every use, as is the case for professional dispensing systems. Also after extended standing time without being used, the device should be thoroughly flushed through before it is put into operation again. However, with the known devices, which cannot be connected with a drinking water line to flush them out, as is the case for professional dispensing systems, this involves a great amount of effort.

### SUMMARY OF THE INVENTION

It is therefore an object of the present invention to provide a beverage cooling and dispensing device which makes it possible, right from the start, to dispense fresh, well carbonated beverages.

This object is accomplished according to the invention in that the compressed gas system for dispensing the beverage and/or for cleaning the line has at least one replaceable compressed gas cartridge containing approximately 10 g to approximately 30 g gas, the volume of which is adapted to the volume of the beverage supply container in such a manner that the content of the beverage supply container can be dispensed with a single compressed gas cartridge. The cooling device has a flow-through or batch cooler, the volume of which corresponds to approximately 0.02 times to approximately 0.1 times the volume of the beverage supply container. The beverage supply container can have a volume of approximately 3 L to approximately 15 L.

The coordination of the volumes of the compressed gas cartridge and the cooling device with the volume of the beverage supply container brings about the result that the beverage can be dispensed with sufficient carbonation, without having to replace the cartridge. Furthermore, only an amount of the beverage that is suitable for consumption is cooled at all times. This allows very rapid cooling of the beverage to a temperature that is pleasant for drinking, even if the beverage supply container was not cooled before use, or was even heated, for example due to the effect of sunshine. In other words, it is possible for the first time, using the device according to the invention, to dispense several glasses of the beverage at the optimal temperature, only a very short period of time after tapping a keg.

It is particularly preferred if the volume of the flow-through or batch cooler disposed between the tapping unit and the tap amounts to approximately 0.1 L to approximately 1.0 L, preferably between approximately 0.2 L to approximately 0.5 L.

According to the invention, the compressed gas system has a pressure regulation device having at least one pressure and/or temperature sensor. The pressure regulation device is configured in such a manner that the pressure of the gas can be regulated as a function of the pressure and/or of the temperature of the beverage.

The compressed gas cartridge, which is preferably a 16 g cartridge, can be connected with the compressed gas system by way of a quick coupling device. This allows rapid and easy replacement of a CO₂ cartridge even while a keg or the like is connected with the device. The pressure of the compressed gas, particularly CO₂, in the compressed gas system can be adapted to the beverage, by means of the pressure regulation device, as a function of the parameters of temperature and/or pressure. In this way, it is possible to avoid over-carbonation or under-carbonation of the beverage.

According to the invention, the compressed gas system is used not only for dispensing the beverage, but also for cleaning at least the line between the beverage supply container and the tap. With the invention, the line can be blown dry after use by the compressed gas, so that independent of a prior flushing process, almost no residue remains in the line. At the same time, the compressed gas remains in these lines after they are blown dry, so that the growth of algae or germs is made significantly more difficult, due to the absence of oxygen. Therefore, there is risk that stale residues of the previously dispensed beverage and/or germs and/or algae will be flushed out of the device with the first dispensed glasses when the device according to the invention is put into use again. Consequently, a fresh and hygienically perfect beverage, which is furthermore properly carbonated, can be dispensed with the beverage cooling and dispensing device according to the present invention, right from the first glass.

According to a preferred embodiment of the invention, the quick coupling device of the compressed gas system is configured for connecting a compressed gas cartridge, particularly a commercially available CO₂ cartridge. Coupling of the compressed gas cartridge takes place by means of a rotational movement, a displacement movement, and/or a pivoting movement. For this purpose, an accommodation for a compressed gas cartridge that opens in the manner of a flap can be provided on a side of the device, which cartridge is displaced or pivoted in such a manner, by closing the accommodation, that the compressed gas cartridge is coupled onto the compressed gas system. Alternatively to this, a switch-like device can also be provided, by means of which the compressed gas cartridge can be pivoted or displaced in such a manner that it is connected with the compressed gas system.

In order to be able to dispense several kegs of a beverage using the device according to the invention, the compressed gas system can be configured so that replacement of the compressed gas cartridge is possible during operation. Alternatively or in addition to this, a pressure chamber can also be provided, into which the contents of several compressed gas cartridges can be filled. Furthermore, a so-called multi-docking station can also be provided, in other words a system having connectors for several compressed gas cartridges. The rapid replacement of a compressed gas cartridge is made possible with the invention because such a cartridge does not have to be screwed into a corresponding coupling, but rather can be coupled on by means of a displacement movement and/or pivoting movement.

In a further embodiment of the invention, the temperature sensor is configured and disposed for detecting the beverage temperature in the line and/or for detecting the outside temperature of the beverage supply container. In this connection, the temperature sensor can be an integral part of a thermally regulated valve. Furthermore, the pressure sensor can be configured and disposed for detecting the beverage pressure in the line and/or for detecting the beverage pressure in the beverage supply container.

Very precise regulation of the gas pressure in the compressed gas system can be achieved if a data processing device is assigned to the pressure and/or temperature sensor, which regulates the pressure of the compressed gas as a function of the pressure and/or temperature data of the pressure and/or temperature sensor. Several sensors, independent of one another, can also be provided for detecting the pressure and/or the temperature.

In order to prevent the beverage from spraying out in an uncontrolled manner when tapping a new keg, it is preferred if the tapping unit has a tapping sword having an automatically closing kick-back valve disposed in the line for gas and/or liquid, which valve blocks the flow of liquid out of the beverage supply container in the unstressed state. For large kegs that are used in bars or the like, such kick-back valves are already known, in part. However, there are as yet no tapping swords, particularly for five-liter party kegs, that close automatically, by means of a kick-back valve for gas and beer. Therefore, it is possible to store a keg provided with such a tapping unit in the partially emptied state, over an extended period of time, without gas or liquid exiting from the keg. A five-liter party keg therefore does not even have to be used up. opening of the kick-back valve can take place, according to the invention, by way of the pressure of the compressed gas system and/or by way of a spring-loaded pin, for example, or similar opening mechanism, if the tapping unit is completely coupled onto the system, for example by way of an adapter flap.

According to yet another embodiment of the invention, the tapping unit has an adapter for connecting a larger (additional) beverage supply container and/or another compressed gas source. Thus, not only commercially available five-liter party kegs, but also beer kegs of 10 to 60 liters can be used. In this way, the range of use of the beverage cooling and dispensing device according to the invention is significantly expanded. In addition or alternatively to this, the beverage cooling and dispensing device can also be connected to a CO₂ bottle, by way of the adapter, in order to supply the compressed gas system with compressed gas.

Temperature control of the beverage, which is particularly effective, according to the invention, takes place in that the cooling device has a flow-through cooler that is disposed between the tapping unit or the tap. The flow-through cooler can work according to the compression method, for example, and consist of a compressor, a liquefier, an expansion valve, and an evaporator (dry block), whereby the beverage gets from the beverage supply container by way of a hose or similar line, into the cooling block, which is configured as a dry block, and exits from the flow-through cooler again by way of a hose or similar line connected with the tap. Alternatively or in addition, the cooling can also take place by means of Peltier elements and/or zeolite coolers. The beverage supply containers therefore do not have to be pre-cooled before use, for several hours, but instead can be put into operation almost independent of their temperature.

Alternatively or in addition to the flow-through cooler, the cooling device can also have a contact cooler for the beverage supply container and/or a batch cooler, which in turn is preferably disposed between the tapping unit and the tap. Contact cooling of the beverage supply container makes it possible to cool the keg or the like itself, so that the temperature of the complete beverage supply in the keg is affected. A batch cooler is a cooler in which a small volume of beverage, usually the amount of about one to two glasses, is cooled immediately before being taken from the tap. Consequently, cooled beverage can be dispensed more quickly with a batch cooler than in the case of exclusive contact cooling of the beverage supply container.

In order to allow an appealing presentation of a beverage, at least one cold light source can be provided on the beverage cooling and dispensing device, in such a manner that the tap, a beverage stream exiting from the tap, a vessel for presenting the beverage, such as a glass, and/or a drip bowl can be illuminated. Such an illumination can also be controlled so that the drip bowl or the glass is only illuminated when the glass is positioned under the tap. In the same manner, the tap can also be illuminated in such a manner that when the tap is activated, it and/or the beverage stream are illuminated. In this connection, the beverage is not supposed to come into contact with the light source, in order to avoid undesirable warming of the beverage. In order to allow the illumination, the tap, which is preferably removable, or the drip bowl can be equipped with corresponding contact points to the beverage cooling and dispensing device.

Furthermore, a control device, which is connected with at least one display device, is preferably assigned to the compressed gas system. Thus it is possible, for example, to display the temperature and/or the pressure of the beverage and/or the compressed gas by means of a numerical display, or by means of appropriate monitoring lights. Also, a display can be present that indicates the operating readiness of the device to the user, or indicates that a replacement of the compressed gas cartridge or cleaning of the device is required.

According to a preferred embodiment of the invention, the compressed gas system is configured in such a manner that the line can be filled with compressed gas before or while a beverage supply container is connected to the tapping unit. In the case of these so-called pre-pressures, a counter-pressure for the beverage builds up in the lines, by means of the compressed gas, so that even the first glasses of the beverage can be dispensed without excessive foam.

If the compressed gas system is configured in such a manner that at least the line and the tapping unit can be flushed with a cleaning agent and/or compressed gas, particularly an inert gas such as CO₂, the beverage cooling and dispensing device can be thoroughly cleaned after use and before being put into use again, so that no beverage residues remain in the lines, and also the growth of algae or germs is made more difficult.

In addition or alternatively to the characteristics described above, in the case of a beverage cooling and dispensing device according to the invention, the tapping unit is securely disposed in the head or lid region of the beverage cooling and dispensing device, for example. This can take place by guidance of the tapping unit and/or by means of fixation of the tapping unit, as soon as the beverage supply container has been tapped. For this purpose, at least the tapping sword of the tapping unit can be guided by a head or lid region of the beverage cooling and dispensing device, in its position connected with the beverage supply container. Furthermore, the tapping unit can be releasably locked in a head or lid region of the beverage cooling and dispensing device.

According to a preferred embodiment, the tapping unit can be locked in a head or lid region of the beverage cooling and dispensing device as a function of the pressure in the compressed gas system. For this purpose, a blocking means, particularly a pressure cylinder unit, which can be activated by the pressure in the compressed gas system, can be provided on the tapping unit and/or in a head or lid region of the beverage cooling and dispensing device, in order to lock the tapping unit in the beverage cooling and dispensing device.

The invention furthermore relates to a set composed of a beverage cooling and dispensing device and a cleaning container, particularly one configured as a cleaning keg, which can be connected with the tapping unit of the beverage cooling and dispensing device. In this connection, the cleaning keg or the cleaning container, according to the invention, has a first chamber for accommodating a liquid, particularly water, and a second chamber for accommodating a cleaning agent, for example a tablet or the like, which is connected with the first chamber. The tapping unit can be introduced at least partially into the second chamber. After operation of the beverage cooling and dispensing device, the cleaning keg can be connected in place of the beverage supply container, for example one configured as a five-liter party keg, in order to flush out the device and clean it.

In this connection, cleaning agent from the second chamber is first passed through the system, and subsequently, water or the like is passed through the lines to flush out the system. If necessary, the lines can finally be blown dry by means of the compressed gas. The cleaning agent can be provided either in dry form, as a powder or tablet, and can dissolve in the water or the like from the first chamber, or liquid cleaning agent can be used.

In order to facilitate connecting the cleaning container to the beverage cooling and dispensing device, the cleaning container preferably has the dimensions of a five-liter product container, particularly a conventional five-liter party keg.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of an embodiment of a beverage cooling and dispensing device according to the invention, having a beverage or cleaning keg;

FIGS. 2a, 2b show a sectional view of a tapping sword and a tapping unit according to a first embodiment of the invention; and

FIG. 3 shows a sectional view of a tapping unit according to a second embodiment of the invention.

### DETAILED DESCRIPTION OF THE PREFERRED EMBODIMENT

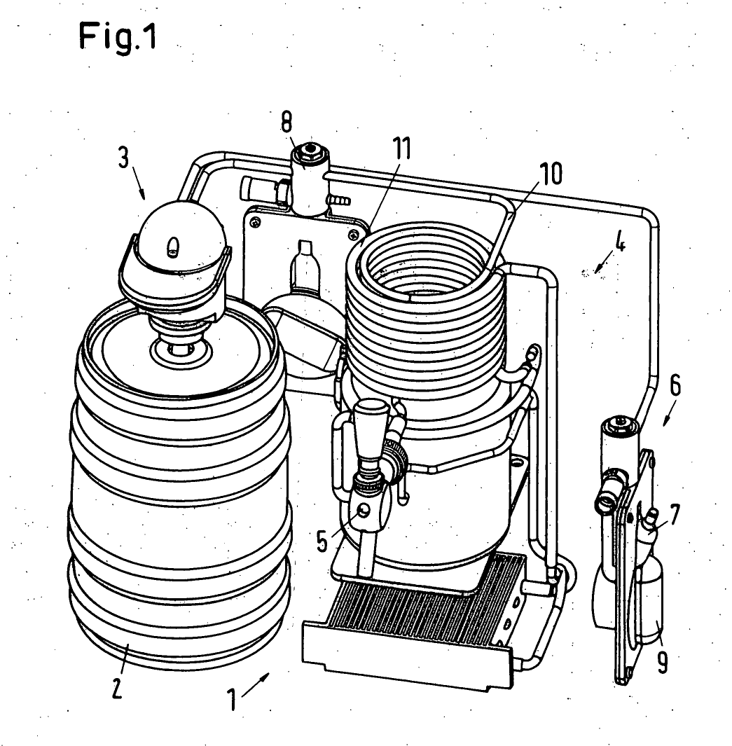

The beverage cooling and dispensing device 1 shown in FIG. 1 is configured for dispensing a beverage accommodated in a beverage supply container 2. For this purpose, beverage cooling and dispensing device 1 has a tapping unit 3 that can be connected with beverage supply container 2, which is configured as a five-liter party keg, for example, a cooling device 4, and a tap 5. Furthermore, a compressed gas system is provided, which consists of a quick coupling device 6 for connecting a compressed gas cartridge 7 and a pressure regulation device 8, which are connected with one another and with tapping unit 3 by way of compressed gas lines.

Quick coupling device 6 is configured in such a manner that a conventional screw-in compressed gas cartridge 7, for example a 16 gram CO₂ cartridge, can be coupled onto the compressed gas system, without compressed gas cartridge 7 having to be screwed in. For this purpose, quick coupling device 6 is provided with an accommodation into which compressed gas cartridge 7 can be pivoted. By means of activating a flap element or switch 9, the compressed gas cartridge 7 is then coupled onto the compressed gas system by means of a displacement movement or pivoting movement, in other words not by the usual method of screwing it in. In this manner, rapid replacement of compressed gas cartridge 7 is possible.

A line 10 leads through the pressure regulation device 8, connecting tapping unit 3 with tap 5. In pressure regulation device 8, a pressure sensor and a temperature sensor are disposed; these are not shown in the drawing. These sensors detect the pressure and the temperature of the beverage flowing through line 10. The gas pressure in the compressed gas system can be regulated by pressure regulation device 8, as a function of these two parameters. In this way, over-carbonation or under-carbonation of the beverage is prevented from occurring.

Cooling device 4 is configured as a flow-through cooler, to which a cooling agent circuit 11 is assigned, which works according to the compression method. After temperature adjustment in the flow-through cooler, line 10 opens into tap 5.

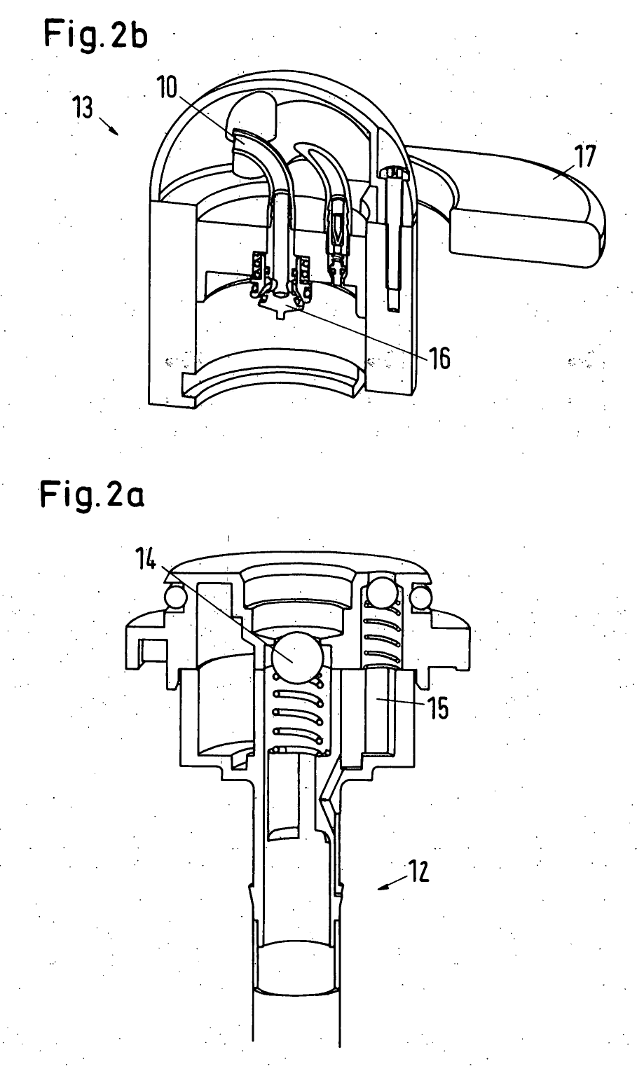

As shown in FIGS. 2a and 2b, tapping unit 3 has a tapping sword 12 and an adapter cap 13. Tapping sword 12 can be introduced into beverage supply container 2 in a sealed manner, and has a kick-back valve 14 at the upper end of its riser pipe that can be connected with line 10 for the beverage. Connector 15 for the compressed gas is also equipped with a kick-back valve, so that when the keg is tapped, neither gas nor liquid can exit from tapping sword 12.

A spring-loaded element 16 is provided in adapter cap 13, for connecting tapping sword 12 to line 10, which element has a projecting pin that opens kick-back valve 14 when adapter cap 13 is set onto tapping sword 12. In this manner, a beverage can pass through adapter cap 13, through the riser pipe of tapping sword 12, and flow through line 10. Opening of the kick-back valve in the compressed gas feed of tapping sword 12 can also take place in spring-loaded manner, or by way of the gas pressure. Adapter cap 13 is provided with a lever 17, by means of which adapter cap 13 can be fixed in place on tapping sword 12 and/or on beverage keg 2.

Furthermore, connectors for an external compressed gas source or a larger beverage keg, for example a 50 liter keg, can be provided on adapter cap 13. In order to achieve protection against damage and contamination, at least cooling device 4 and pressure regulation device 8 can be accommodated in a housing, not shown in the figures.

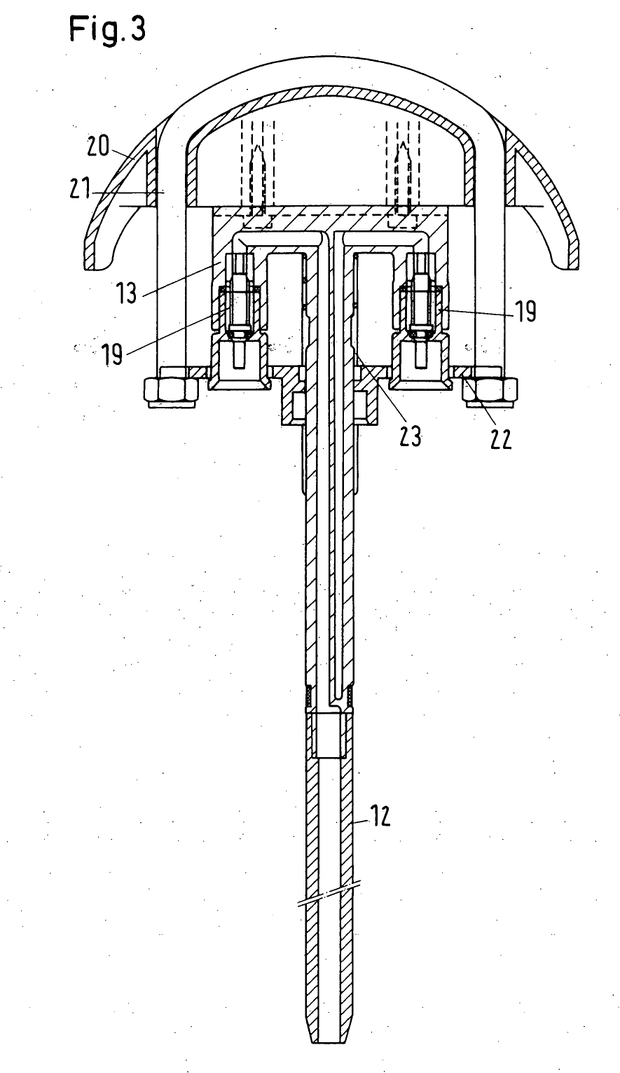

FIG. 3 shows a second embodiment of a tapping unit 18, which also has a tapping sword 12 and an adapter cap 13. Furthermore, two valves 19 are integrated into adapter cap 13, whereby the valve that is on the left in the figure connects a riser line that leads through tapping sword 12 with line 10 that leads through the cooler and to tap 5, while the valve that is on the right in the figure can be used to introduce CO₂ from compressed gas cartridge 7 into beverage supply container 2, for example.

Tapping unit 18 can be introduced in a head or lid region of the beverage cooling and dispensing device, and lid 20 of tapping unit 18 can fit into the round shape, for example, of the head or lid region. Tapping unit 18 is guided in the head or lid region and can be locked in place in its operating position, in which tapping sword 12 is sufficiently inserted into the keg or the like, for example by means of an engagement mechanism. To release this connection, a bracket 21 is provided on tapping unit 18, which can be partially pulled out of tapping unit 18, in order to release tapping unit 18. Bracket 21 works together with a displaceable plate 22, which has the force of a spring 23 applied to it, in the locking position shown in FIG. 3.

Alternatively or in addition, a pressure-dependent blocking device not shown in the figures is provided, which is formed by a pressure cylinder unit. This pressure cylinder unit is connected with the compressed gas cartridge 7 by way of appropriate lines, so that a blocking piston is moved out, locking the tapping unit 18, as soon as compressed gas is applied to the system. In this way, it is assured that tapping unit 18 cannot be accidentally loosened while a filled compressed gas cartridge 7 is connected. The risk that persons will be injured by a tapping unit 18 shooting out due to excessive pressure, if tapping unit 18 is unintentionally loosened, is thereby minimized.

Accordingly, while only a few embodiments of the present invention have been shown and described, it is obvious that many changes and modifications may be made thereunto without departing from the spirit and scope of the invention.

Reference Symbol List:

1 beverage cooling and dispensing device
2 beverage supply container/cleaning keg
3 tapping unit
4 cooling device
5 tap
6 quick coupling device
7 compressed gas cartridge
8 pressure regulation device
9 flap/switch
10 line
11 coolant circuit
12 tapping sword
13 adapter (cap)
14 kick-back valve
15 compressed gas feed
16 spring-loaded element/pin
17 lever
18 tapping unit
19 valve
20 lid
21 bracket
22 plate
23 spring

What is claimed is:

1. A beverage cooling and dispensing device, comprising:
a tapping unit that can be connected with a beverage supply container having a volume of approximately 3.5 L to approximately 11 L, and with a tap by way of a line;
a cooling device for cooling a beverage in at least one of the beverage supply container and the line, said cooling device having a flow-through or batch cooler connected between the tapping unit and the tap, a volume of which flow-through or batch cooler corresponds to approximately 0.02 times to approximately 0.1 times a volume of the beverage supply container; and
a compressed gas system connected to the tapping unit for dispensing the beverage or for cleaning at least the line, said system having at least one replaceable compressed gas cartridge containing approximately 10 g to approximately 30 g gas, a volume of gas in said cartridge being adapted to the volume of the beverage supply container in such a manner that contents of the beverage supply container can be dispensed with a single compressed gas cartridge.

2. A beverage cooling and dispensing device according to claim 1, wherein the volume of the flow-through or batch cooler amounts to approximately 0.1 L to approximately 1.0 L.

3. A beverage cooling and dispensing device according to claim 1, wherein the compressed gas system has a pressure regulation device having at least one pressure or temperature sensor, wherein the pressure regulation device is configured in such a manner that pressure of the gas can be regulated as a function of pressure or of temperature of the beverage.

4. A beverage cooling and dispensing device according to claim 1, further comprising a quick coupling device for connecting the compressed gas cartridge to the compressed gas system, wherein coupling of the compressed gas cartridge takes place via a rotational movement, a displacement movement, or a pivoting movement.

5. A beverage cooling and dispensing device according to claim 1, further comprising a temperature sensor configured and disposed for detecting a temperature of beverage in the line or an outside temperature of the beverage supply container.

6. A beverage cooling and dispensing device according to claim 5, wherein the temperature sensor is an integral part of a thermally regulated valve.

7. A beverage cooling and dispensing device according to claim 1, further comprising a pressure sensor configured and disposed for detecting a pressure of beverage in the line or in the beverage supply container.

8. A beverage cooling and dispensing device according to claim 3, further comprising a data processing device assigned to the pressure or temperature sensor, said data processing device regulating the pressure of the compressed gas as a function of pressure or temperature data of the pressure or temperature sensor.

9. A beverage cooling and dispensing device according to claim 1, wherein the tapping unit has a tapping sword adapted to be introduced into the beverage supply container, and further comprising an automatically closing kick-back valve disposed at least in the line, said valve blocking a flow of liquid out of the beverage supply container in its unstressed state.

10. A beverage cooling and dispensing device according to claim 1, wherein the tapping unit has an adapter for connecting another beverage supply container or another compressed gas source.

11. A beverage cooling and dispensing device according to claim 1, further comprising at least one cold light source that illuminates at least one of the tap, a beverage stream exiting from the tap, a vessel for presenting a beverage, and a drip bowl.

12. A beverage cooling and dispensing device according to claim 1, further comprising a control device assigned to the compressed gas system, said control device being connected with at least one display device.

13. A beverage cooling and dispensing device according to claim 1, wherein the compressed gas system is configured so that the line can be filled with compressed gas before or while a beverage supply container is connected with the tapping unit.

14. A beverage cooling and dispensing device according to claim 1, wherein the compressed gas system is configured to flush at least the line and the tapping unit with a cleaning agent or compressed gas.

15. A beverage cooling and dispensing device according to claim 9, wherein at least the tapping sword is guided by a head or lid region of the beverage cooling and dispensing device in a position connected with the beverage supply container.

16. A beverage cooling and dispensing device according to claim 1, wherein the tapping unit is lockable in place in a head or lid region of the beverage cooling and dispensing device.

17. A beverage cooling and dispensing device according to claim 1, wherein the tapping unit is lockable in place in a head or lid region of the beverage cooling and dispensing device as a function of pressure in the compressed gas system.

18. A beverage cooling and dispensing device according to claim 1, further comprising a blocking means which is activated by pressure in the compressed gas system, said blocking means being provided on the tapping unit or in a head or lid region of the beverage cooling and dispensing device, in order to lock the tapping unit in the beverage cooling and dispensing device.

19. A set comprising a beverage cooling and dispensing device according to claim 1, and a cleaning container connected with the tapping unit of the beverage cooling and dispensing device, wherein the cleaning container is configured as a cleaning keg and has a first chamber for accommodating a liquid, and a second chamber for accommodating a cleaning agent and which is connected with the first chamber, wherein the tapping unit can be introduced at least partially into the second chamber.

20. A set according to claim 19, wherein the cleaning container has the dimensions of a five-liter product container.
